(19) United States
(12) Patent Application Publication
(10) Pub. No.: US 2012/0162467 A1
(43) Pub. Date: Jun. 28, 2012

(54) IMAGE CAPTURE DEVICE

(76) Inventor: Fumiki Nakamura, Kanagawa (JP)

(21) Appl. No.: 13/389,602

(22) PCT Filed: Aug. 19, 2010
(86) PCT No.: PCT/US10/02281

§ 371 Date: Feb. 9, 2012

(30) Foreign Application Priority Data
Aug. 27, 2009 (JP) 2009-197357

(51) Int. Cl. H04N 5/235

(52) U.S. Cl. 348/229.1; 348/E05.034

(57) ABSTRACT

An image capture device quickly reduces noise even when the brightness of a subject has changed. The image capture device has an image capture element such as a CMOS, and an AE/AF control section. When the brightness of a subject decreases, the AE/AF control section increases gain of an amplifier, which is used to amplify an image signal, in the next frame. Simultaneously, the AE/AF control section decreases exposure time so as to compensate for the increase in the gain. The exposure time is later recovered stepwise to the original exposure time.

### CROSS-REFERENCE TO RELATED APPLICATION

This application claims priority to Japanese Patent Application No. 2009-197357 filed on Aug. 27, 2009, which is incorporated herein by reference in its entirety.

### BACKGROUND

1. Technical Field

The present invention relates to image capture devices, and in particular, to a technique of reducing noise when reading moving images.

2. Related Art

Image capture devices including digital cameras and video cameras generally have an automatic exposure amount adjusting function which is called AE. This function is to adjust at least one of gain, exposure time, and an aperture, according to brightness of a subject and the environment. When the brightness suddenly changes, if the gain and the amount of exposure of a device have been set to be changed directly according to the brightness, a feeling of strangeness will be caused in the image. Particularly, when the luminance of the subject suddenly changes on the scene, that is, in a room with a window for example, when the camera is panned from indoors to the window or from the window to indoors, if AE response is too quick, the brightness changes by each frame so that the image becomes very unstable. As such, the gain and the amount of exposure are generally adjusted to gradually reach predetermined values even when the brightness has changed.

In recent years, CIS (CMOS image sensors) have been increasingly used as image capture elements of image capture devices, in consideration of the high-speed performance and low power consumption. Many CISs have a noise reducing function therein. A typical noise reducing method is performed such that a pixel section includes a PD (photo detector) section and an FD (floating diffusion) section, and the FD section is first reset and a pixel signal (dark reference signal) is read from a pixel amplifier connected to the FD section. Then, an optical charge is transferred from the PD section to the FD section, and a pixel signal (bright signal) containing an optical signal is read through the pixel amplifier, and a difference between the two signals is calculated to thereby reduce the noise.

In this method, although noise caused by variation in the reset levels generated in respective pixels can be reduced, linear row and column noise caused by variation in column amplifiers cannot be reduced.

As a method of reducing row and column noise, there is one in which a dark reference signal output pixel section is provided, besides effective pixel signals. The dark reference signal output pixel section is configured of light shielded pixels or pixels where the PD section is not connected to the FD section. Subtracting dark reference signals from each pixel signal in which noise of respective pixels is reduced, a difference is further calculated by each row and each column, to thereby reduce the noise. The dark reference signals are often taken from a plurality of frames for stability. When gain is changed, the dark reference signals are reset. As such, as the reference signals in the first several frames are unstable, the noise may be high.

When AE function is operated, gain is first adjusted, generally. Then, when the brightness of the subject is changed, the gain is usually changed stepwise in accordance with the brightness.

FIG. 6 is a conventional operation timing chart when AE is operated. FIG. 6(a) shows frame number, and FIG. 6(b) shows changes in the brightness (luminance) of a subject or surrounding environment thereof. FIG. 6(b) illustrates that the brightness is constant from frame No. 1 to frame No. 10, and suddenly drops to a half level at the frame No. 11. FIG. 6(c) shows changes in the gain. Even when the brightness has changed suddenly, the gain increases stepwise, rather than quickly following the change. For instance, if the gain in frames No. 1 to No. 10 is 1×, even when the brightness drops suddenly at the frame No. 11, the gain is maintained at 1× until frame No. 12, and in frames No. 13 to No. 16, the gain is sequentially increased from 1× to 1.19×, 1.41×, 1.68×, and 2×. Then, in frame No. 16 and after, the optical signal is amplified by 2× which is the gain corresponding to the brightness of frame No. 11 and after. FIG. 6(d) shows changes in the exposure time Tint. In this case, the exposure time is constant at 1/30 s. FIG. 6(e) shows changes in the row/column noise. When the gain is increased, noise is generated because the reference signals are reset as described above. As the gain is increased stepwise in frames No. 13 to No. 16, noise is generated in this period. As the gain becomes constant at 2× in frame No. 16 and after, the noise is reducing.

JP 2007-251236 A discloses relatively increasing photographing sensitivity by increasing the gain of an amplifier for sensitivity adjustment, and removing adverse effects of parallel blurs caused in close distance photography by setting the shutter speed to be relatively high.

However, in the method of gradually changing the gain when the brightness of the subject or the surrounding environment thereof has changed suddenly, a plurality of frames are required until the noise level becomes stable at a normal level after the final target gain has been set. For example, in FIG. 6, the noise level gradually decreases in frames No. 16 to No. 19, and decreases to a normal level in frame No. 20. In this period, noise has to be contained in the obtained images. In order to prevent this problem, although it is one option to increase the number of pixels in the dark reference signal output section, this increases reading time for one frame, so that the frame rate drops.

### SUMMARY

It is an advantage of the present invention to provide a device capable of quickly reducing noise even when the brightness of a subject (or surrounding environment thereof) has changed suddenly.

According to an aspect of the present invention, an image capture device of the present invention includes an image capture element, an amplification unit that amplifies an image signal output from the image capture element, a light measuring unit that measures brightness of a subject based on the image signal, and a control unit that controls gain of the amplification unit and an amount of exposure based on the brightness measured by the light measuring means, wherein the control unit changes the gain in accordance with a change in the brightness, changes the amount of exposure so as to compensate for the change in the gain, and later recovers the amount of exposure to an original exposure value which was used before the value was changed.

In an embodiment of the present invention, when the brightness decreases, the control unit increases the gain, and decreases the amount of exposure so as to compensate for the increase in the gain.

In another embodiment of the present invention, when the brightness decreases, the control unit increases the gain, and decreases exposure time or an aperture value so as to compensate for the increase in the gain.

According to another aspect of the present invention, an image capture device of the present invention includes an image capture element, an amplification unit that amplifies an image signal output from the image capture element, a light measuring unit that measures brightness of a subject based on the image signal, and a control unit that, when the brightness measured by the light measuring unit decreases in one frame, controls gain of the amplification unit to increase in the next frame to the one frame so as to achieve target signal level, and also controls exposure time or an aperture value to decrease, and in a subsequent frame and after, recovers the exposure time or the aperture value stepwise to an original exposure time or an original aperture value which was used before the control of decreasing was performed.

According to the present invention, noise can be quickly reduced even when the brightness of the subject has changed.

### BRIEF DESCRIPTION OF THE DRAWINGS

FIG. 1 is a block diagram showing the configuration of an embodiment;

FIG. 2 is a block diagram showing the configuration of another embodiment;

FIG. 3 is a process flowchart of an embodiment;

FIG. 4 is a timing chart of the embodiment;

FIG. 5 is a timing chart of another embodiment; and

FIG. 6 is a timing chart of conventional art.

### DETAILED DESCRIPTION

An embodiment of the present invention will be described below based on the drawings.

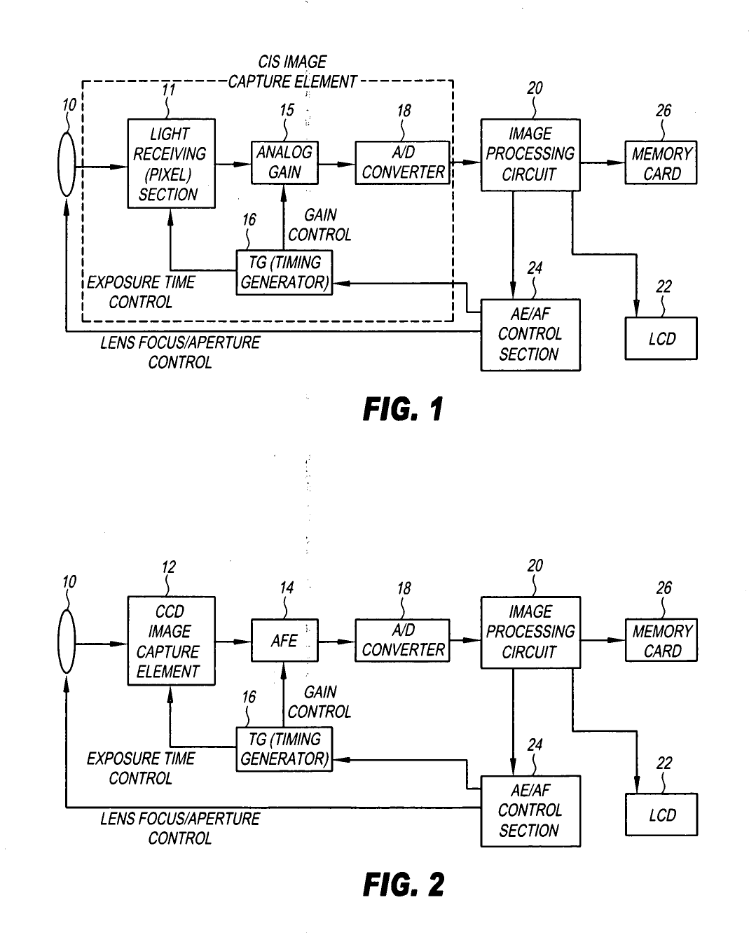

FIG. 1 is a block diagram showing the configuration of a digital camera having a moving image photographing function as an image capture device of the present embodiment. An optical system 10, including a focus lens, a zoom lens, a shutter, and an aperture, forms a subject image on a CIS (CMOS image sensor) image capture element.

The CIS image capture element is configured such that a light receiving section 11, an analog gain 15, an A/D converter 18, and a timing generator 16 are integrated in one chip. Although an infrared cut filter and an optical low-pass filter are arranged between the optical system 10 and the CIS image capture, element, they are not shown in FIG. 1. Further, the CIS image capture element is provided with a microlens array and a color filter of Bayer arrangement. In the CIS image capture element, an accumulated charge is read by one pixel, among the pixels arranged in a matrix, by specifying the row and the column in the selection circuit. It should be noted that in a CIS image capture element of a passive type, a signal charge stored in the PD (photodiode) is directly output to the output circuit, while in a CIS image capture element of an active type, a change in the potential caused in the PD (photodiode) is output. This means that in the case of an active type, a signal charge stored in the PD (photodiode) is completely transferred to the FD (floating diffusion), and is converted into a voltage signal by the amplifier and is output.

The analog gain 15 includes an AGC (auto gain controller), and amplifies and outputs an image signal. The gain of the AGC is controlled by the timing generator (TG).

The AD converter converts an analog voltage signal into a digital signal and outputs it.

The image processing circuit 20 performs respective processes of gain correction (white balance sensitivity setting), gamma correction, color interpolation, RGB-YC transformation, noise reduction, edge enhancement, and JPEG compression. In the gain correction, gain is corrected with a gain correction coefficient calculated from respective RGB signals. Methods of calculating a gain correction coefficient include a method in which gain correction coefficients such as tungsten, fluorescent light, clear weather, and the like have been set beforehand and a user manually switches among them, a method in which average values of respective RGB signals are calculated and a gain correction coefficient is calculated such that the respective average values become equal, and a method in which histograms of respective RGB signals are calculated and a gain correction coefficient is calculated by estimating the illumination light source color from the histograms. In the gamma correction, outputs of the CIS are adjusted according to the input/output characteristics of the display. In the color interpolation process, an image signal output from the CIS image capture element of Bayer arrangement is divided into an R signal, a G signal, and a B signal, and for each of the color signals, a missing pixel signal is interpolated using surrounding pixel signals. In the color interpolation process, a missing pixel is interpolated by averaging the adjacent pixel values. By using a characteristic that edge portions of an image are generally continuous, a missing pixel may be interpolated using an average of pixel values in a relative direction of the adjacent pixels. In the RGB-YC conversion process, Y, Cr, and Cb signals are generated from RGB signals. Specifically, those signals are generated based on the expressions that Y=0.30R+0.59G+0.11B, Cr=R−Y, and Cb=B−Y. In the edge enhancement, a drop of MTF due to the optical low-pass filter or the like or a drop of MTF due to an influence due to the opening of the CCD is corrected, or the sharpness of the image is improved to thereby sharpen the contrasting density. In the noise reduction process, a smoothing process or removal of isolated points by a median filter is performed. In the JPEG compression, image data is divided into 8*8 blocks, and the image data is compressed by sequentially performing DCT, quantization, and Huffman coding. An image signal acquired as a result of image processing performed in the image processing circuit 20 is output to and displayed on a display (LCD) 22, or is output to and stored in a memory card 26. As the memory card, an SD card or another flash memory may be used.

The AE/AF control circuit 24 performs AE and AF functions. Regarding the AE function, a weighted average value (average luminance level) of an image signal is calculated, and a signal average value is compared with a reference value to thereby determine an exposure value. Light measuring methods (algorithms for calculating average luminance level) include center-weighted metering, spot metering, and multi-zone metering. Regarding the AF function, a contrast detection method or a TTL phase difference detection method may be used. The AE/AF control circuit 24 outputs a control signal to the timing generator (TG) based on the determined exposure value, and the timing generator (TG) controls the gain of the analog front end (AFE) and the exposure time based on the control signal. The AE/AF control circuit 24 also controls focus and aperture of the optical system 10.

Although the CMOS image sensor is used as an image capture element in FIG. 1, a CCD may be used as an image capture element. FIG. 2 is a block diagram showing the configuration using a CCD. A CCD image capture element 12 converts an optical signal of the subject image into an accumulated charge and outputs it. It should be noted that although an infrared cut filter and an optical low-pass filter are arranged between the optical system 10 and the CCD image capture element 12, they are not shown in FIG. 2. Further, the CCD image capture element 12 is provided with a microlens array and a color filter of Bayer arrangement. The CCD transfers a signal charge generated in the PD (photodiode) in a column direction and a row direction using the CCD registers, and converts the signal into a voltage signal in the FD (floating diffusion amplifier) of the last stage, and outputs the signal. The CCD image capture element 12 may be of a full frame type, a frame transfer type, an interline type, or a frame interline type.

With this configuration, when the brightness of the subject or the surrounding environment thereof changes suddenly, the image capture device of present embodiment rapidly or quickly changes the gain in accordance with the brightness, rather than changing the gain gradually or stepwise as in the conventional art. In association with the change in the gain, the image capture device simultaneously changes the amount of exposure so as to compensate for the change in the gain. If the gain is changed rapidly, the image will become very unstable so that the user may feel unease, as described above. However, by changing the amount of exposure so as to compensate for the change in the gain, such unease can be suppressed.

As such, when the brightness suddenly decreases, the gain is rapidly increased to the target level, and also, the amount of exposure is simultaneously decreased so as to compensate for the increase in the gain. By decreasing the amount of exposure, unease is lowered by preventing a situation where the brightness changes rapidly in each frame. As it is only required to decrease the amount of exposure by the amount of increase in the gain, if the original gain is G, the original amount of exposure is L, the gain after the change is G′, and the amount of exposure after the change is L′, the amount of exposure after the change L′ can be determined from L′=G/G′*L. The method of determining the amount of exposure is not limited to this expression, of course. The amount of exposure may be determined to have negative correlation with the gain such that the amount of exposure is decreased corresponding to the increase in the gain. In order to change the amount of exposure, it is only necessary to change the exposure time, which may be reduced according to the amount of increase in the gain.

After the amount of exposure has been decreased in accordance with the increase in the gain, the amount of exposure is increased stepwise up to the original amount of exposure (the original amount of exposure before being decreased), while maintaining the gain. Although noise largely depends on the gain, it does not depend much on the amount of exposure. As such, even though the amount of exposure is increased stepwise, noise will never increase in accordance with this increase.

In the present embodiment, noise can be quickly reduced by rapidly changing the gain (at once) rather than changing it stepwise, and instead changing the amount of exposure (exposure time) stepwise.

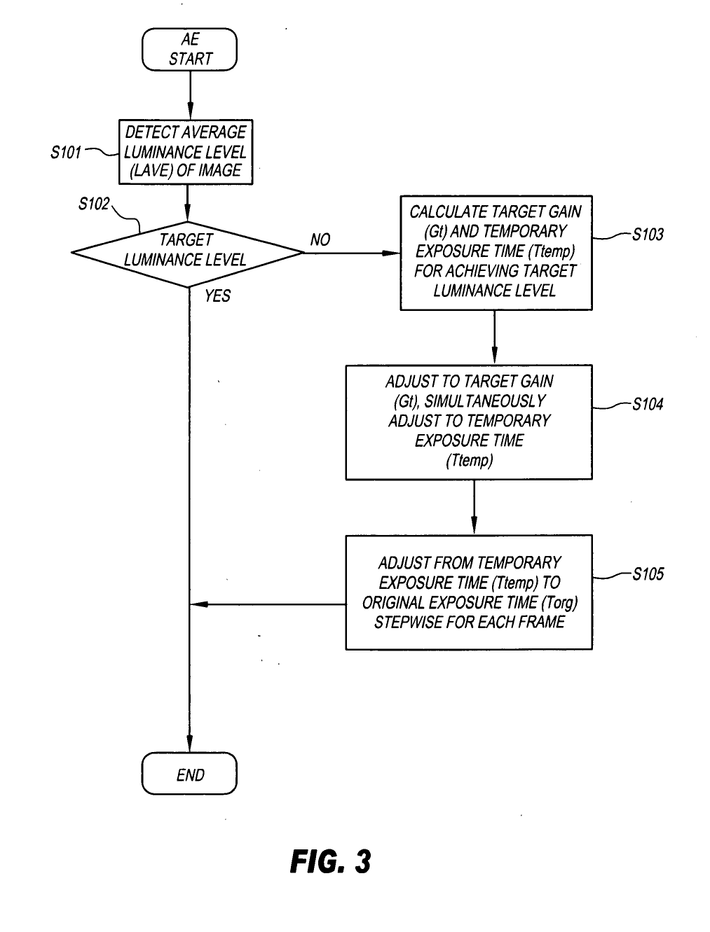

FIG. 3 shows a process flowchart at the time of AE operation in the present embodiment. It is assumed that gain relative to certain luminance is Gc and exposure time is Torg. The AE/AF control section 24 detects an average luminance level of the image (S101). This average luminance level is set to be Lave. Next, the AE/AF control section 24 compares the average luminance level with a target luminance level, and determines whether or not the average luminance level is the target luminance level (S102). If the average luminance level is the target luminance level, the current gain and the exposure time are maintained. On the other hand, if the average luminance level differs from the target luminance level, the AE/AF control section 24 calculates target gain and temporary exposure time for achieving the target luminance level (S103). If the target luminance level is Lt and the target gain is Gt, the target gain Gt is expressed as Gt=Lt/Lave. Further, if the temporary exposure time is Ttemp, the temporary exposure time Ttemp is expressed as Ttemp=Gc/Gt*Torg. The reason for setting the temporary exposure time is that although the amount of exposure is decreased to compensate for the increase in the gain, the amount of exposure is then recovered to the original value stepwise, as described above.

After calculating the target gain Gt and the temporary exposure time, the AE/AF control section 24 controls the gain to be the target gain Gt and also controls the exposure time to be the temporary exposure time Ttemp (S104). Then, the AE/AF control section 24 controls the exposure time to recover from the temporary exposure time to the original exposure time Torg stepwise by each frame (S105).

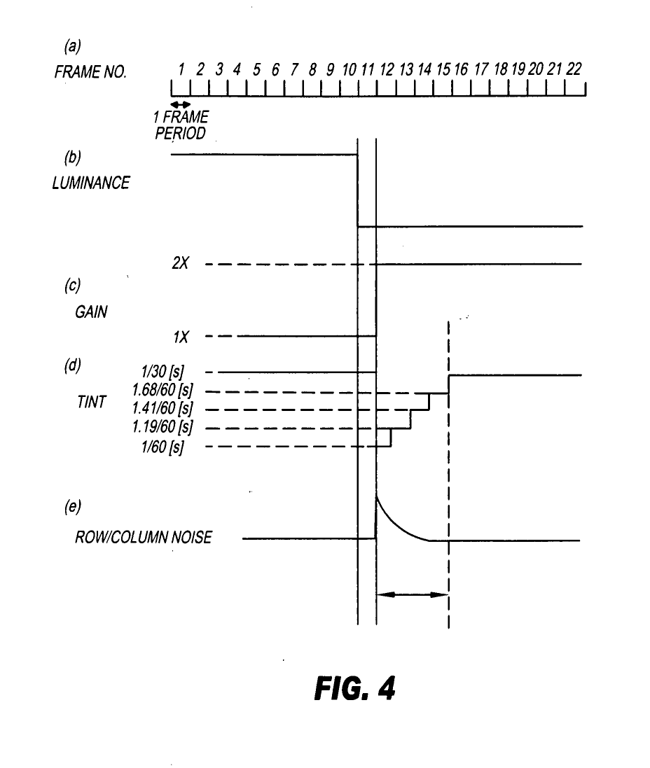

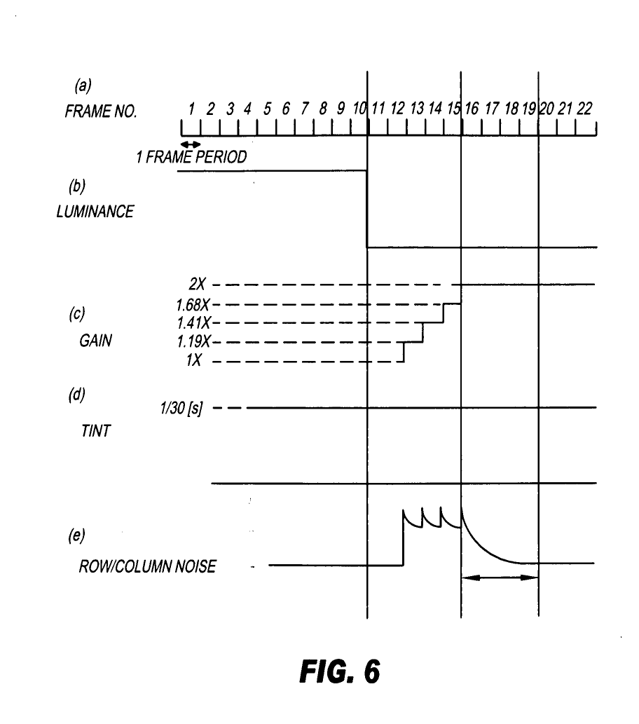

FIG. 4 shows a timing chart of the present embodiment. The characteristics of the present embodiment will be clearly understood in FIG. 4, when compared with FIG. 6 showing the conventional timing chart. FIG. 4(a) illustrates a frame number, and FIG. 4(b) illustrates a change in the brightness (luminance) of the subject or the surrounding environment. In frame No. 11, the brightness suddenly decreases by half. FIG. 4(c) illustrates a change in the gain. Corresponding to the sudden decrease in the brightness in frame No. 11, the gain is increased from 1× to 2× in frame No. 12. FIG. 4(d) illustrates changes in the exposure time. Corresponding to the sudden increase in the gain from 1× to 2× in the frame No. 12, the exposure time is decreased from 1/30^{th} of a second to 1/60^{th} of a second in order to compensate for the increase. Then, during the period of frames No. 13 to 15, the exposure time is increased stepwise from 1/60^{th} of a second to 1.19/60^{th} of a second, 1.41/60^{th} of a second, 1.68/60^{th} of a second, and 1/30^{th} of a second. In frame No. 16, the exposure time is recovered to the original exposure time of 1/30^{th} of a second. FIG. 4(e) illustrates changes in the row/column noise level. The noise level is largely affected by the gain, and seldom depends on the exposure time. As such, as the gain is increased from 1× to 2× in frame No. 12, the noise level is also increased. After the increase, the noise level is gradually decreased. During this period, the gain is constant. In the timing chart of FIG. 6, as the gain becomes constant at 2× in frame No. 16, the noise level begins to decrease from this point. However, in the timing chart of FIG. 4, as the gain becomes constant at 2× in frame No. 12, the noise level is gradually decreased from this point. As the noise level begins to decrease at an earlier stage in the timing chart of FIG. 4 compared with the timing chart of FIG. 6, the noise level is reduced to the original level at an earlier time. As such, the user can obtain an image signal with no noise (or in which noise is reduced) earlier.

It should be noted that in the present embodiment, noise is prominent when high gain is required, which means a dark environment. As such, it is preferable to perform control similar to the conventional one when the brightness changes from dark to bright, and to control gain and exposure time as described in the present embodiment when the brightness changes from bright to dark.

Further, although in the present embodiment gain is rapidly increased in the next frame when the brightness suddenly changes from bright to dark, it is also possible to increase the gain stepwise as the conventional art, but more rapidly than the conventional art, and to decrease the exposure time to compensate for the increase at the time of rapid increase in the gain.

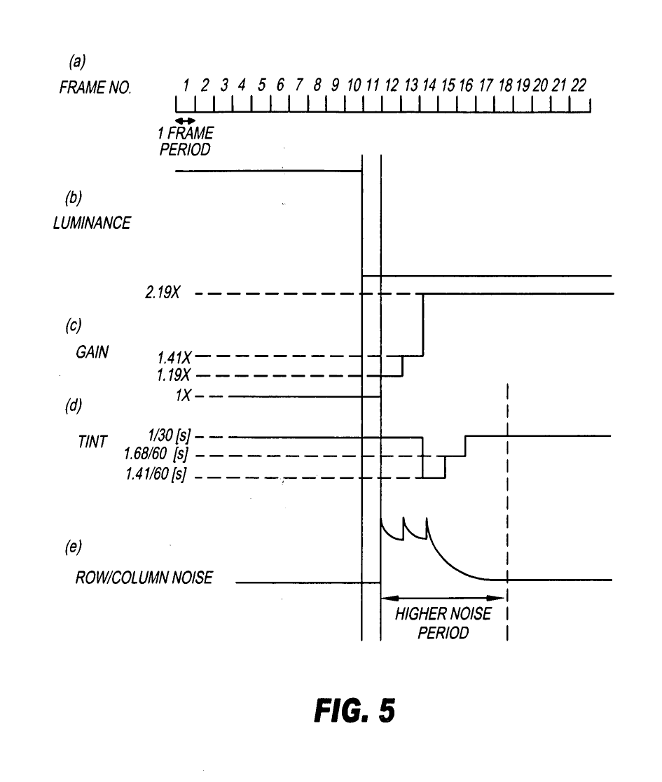

FIG. 5 shows a timing chart of this case. When the brightness suddenly decreases in frame No. 11 as shown in FIG. 5(b), the gain is increased stepwise from the next frame from 1× to 1.19× and to 1.41× as shown in FIG. 5(c). Then, in frame No. 14, the gain is rapidly increased from 1.41× to 2×. As shown in FIG. 5(d), during the period in which the gain is increased stepwise from 1× to 1.41×, the exposure time is maintained at 1/30^{th} of a second, and at the time when the gain is rapidly increased, the exposure time is decreased from 1/30^{th} of a second to 1.41/60^{th} of a second to compensate for the rapid increase. Thereafter, the exposure time is increased stepwise, and reaches the original exposure time of 1/30^{th} of a second in frame No. 16. FIG. 5(e) shows changes in the noise level in this embodiment. As the noise level decreases from frame No. 14 where the gain becomes constant, even in this embodiment it is possible to obtain an image signal with no noise at an earlier time, compared with the case of FIG. 6.

While the present invention converges a temporary increase in the noise, caused in accordance with a change in the gain, at an earlier stage by rapidly increasing the gain to the target gain during a stepwise brightness adjusting period which corresponds to the period of frames No. 12 to 15 in FIG. 4, there is a possibility of increasing the noise during the stepwise brightness adjusting period. However, as this period is an active period in which the brightness is changing stepwise, noise is less noticeable compared with that in a period when the brightness is stable, so that this does not cause a problem in general. If there is some disturbing noise, countermeasures may be taken by optimizing changes in the gain and changes in the amount of exposure as shown in FIG. 5 so as to prevent drastic changes in the gain, or by temporarily applying a strong noise filter in the image processing operation only during the brightness adjusting period.

It should be noted that although the exposure time is used as a means for changing the amount of exposure stepwise in the embodiment described above, it is also acceptable to change the aperture value instead, or to change both.

1. An image capture device, comprising:
an image capture element;
an amplification unit that amplifies an image signal output from the image capture element;
a light measuring unit that measures brightness of a subject based on the image signal; and
a control unit that controls gain of the amplification unit and an amount of exposure based on the brightness measured by the light measuring means, wherein the control unit changes the gain in accordance with a change in the brightness, changes the amount of exposure corresponding to the brightness before change so as to compensate for the change in the gain, and later gradually recovers the amount of exposure to an original exposure value which was used before the value was changed.

2. The image capture device according to claim 1, wherein
when the brightness decreases, the control unit increases the gain, and decreases the amount of exposure corresponding to the brightness before change so as to compensate for the increase in the gain.

3. The image capture device according to claim 2, wherein
when the brightness decreases, the control unit increases the gain, and decreases exposure time or an aperture value corresponding to the brightness before change so as to compensate for the increase in the gain.

4. The image capture device according to claim 3, wherein
when the brightness decreases, the control unit increases the gain from first gain G1 to second gain G2, and decreases the exposure time from first exposure time T1 to second exposure time T2 so as to compensate for the increase in the gain to thereby establish a relationship of T2=G1/G2*T1.

5. An image capture device, comprising:
an image capture element;
an amplification unit that amplifies an image signal output from the image capture element;
a light measuring unit that measures brightness of a subject based on the image signal; and
a control unit that, when the brightness measured by the light measuring unit decreases in one frame, controls gain of the amplification unit to increase in the next frame to the one frame so as to achieve target brightness, and also controls exposure time or an aperture value to decrease so as to achieve the brightness before decrease, and in a subsequent frame and after, recovers the exposure time or the aperture value stepwise to an original exposure time or an original aperture value which was used before the control to decrease was performed.
